(19) United States
(12) Patent Application Publication
(10) Pub. No.: US 2019/0119444 A1
(43) Pub. Date: Apr. 25, 2019

(54) PROCESS TO REMOVE DMC CATALYSTS FROM POLYETHER CARBONATE POLYOLS

(71) Applicant: Covestro LLC, Pittsburgh, PA (US)

(72) Inventors: Sharlene Lewis, Pittsburgh, PA (US); Peter Uthe, Hickory, NC (US); William Koshut, Beaver Falls, PA (US)

(21) Appl. No.: 15/793,340

(22) Filed: Oct. 25, 2017

(51) Int. Cl. C08G 65/26; B01J 27/26; C08G 64/18; C08K 3/04

(52) U.S. Cl. CPC C08G 65/2663; B01J 27/26; C07B 63/00; C08K 3/04; C08G 64/183

(57) ABSTRACT

This invention relates to a process for the production of a high purity polyether carbonate polyol. The high purity polyether carbonate polyols prepared by the process herein contain a low level of catalyst residue. The process purifies polyether carbonate polyol through use of activated carbon, mixed into the polyether carbonate polyol and later removed. In addition, the activated carbon may be coated on the filter through which the polyether carbonate polyol is filtered to form the high purity polyether carbonate polyol.

### FIELD

This invention relates to a process to remove double metal cyanide (DMC) catalysts from polyether carbonate polyols. This invention relates to improving the purity of polyols by reducing the remaining catalyst in the polyols.

### BACKGROUND

Various types of polyols having different degrees of purity are commercially available. The market is consistently trending to higher purity products. The purity of polyols is affected by a wide variety of issues, including the residual catalyst used to prepare the polyols. The ability to remove the catalyst from the polyols provides the opportunity to recycle and reuse the catalyst.

Double metal cyanide (DMC) catalysts can be used to prepare, various types of polyols such as, for example, polyether polyols, polyether ester polyols and/or polyether carbonate polyols. DMC complexes typically consist of a multiphase framework in which Zn²⁺ and [Co(CN)₆]³⁻ ions are linked by the cyanide groups of the complex ion. Methods are being developed for the removal of DMC catalysts from various types of polyols to increase the purity of the polyols and increase the sustainability of the technology (catalyst recycle).

Many processes have been proposed in the literature to eliminate the catalyst from polyols. The most common method is the treatment of the catalyst containing polyol with an alkali metal, hydride or hydroxide, which generates an iconic form of the catalyst and promotes agglomeration, followed by removal of the catalyst by filtration. Such methods are described in, for example U.S. Pat. No. 5,416,241 (believed to correspond to EP 0 665 254 B1) and U.S. Pat. No. 4,877,906. Another method for removal is treatment of the polyol with an oxidant such as hydrogen peroxide or oxygen containing gas, followed by filtration, as described in U.S. Pat. Nos. 5,099,075 and 5,235,114. Other examples include treatment with an acid or polymeric acid that forms chelates with the catalyst, and allows for filtration. (See U.S. Pat. Nos. 5,248,833, 6,806,348 and 7,678,944). Other methods of removing DMC catalysts from polyols are disclosed in U.S. Pat. Nos. 5,144,093; 5,010,047; 4,987,271; 4,721,818 and 4,355,188.

There are inherent issues or problems with the above described treatment methods. These include the need for careful control over the chemical additive to ensure that the product itself is not adversely affected. There is also the added complexity of deactivating and/or removing the added chemical itself from the polyol. In the case of polyols that contain hydrolytic groups such as with polyether carbonates, chemical treatments with compounds such as alkali metals and salts are not appropriate due to chemical attack of the carbonate linkage, which potentially damages the polyol material and leads to uncontrolled broadening of the molecular weight distribution.

Inorganic adsorbents have also been successfully used to remove DMC catalysts from polyols. Both U.S. Pat. Nos. 6,930,210 and 8,354,559 (believed to correspond to EP 2058352B1) disclose that polyether polyols can be purified such that they are high purity polyether polyols with low levels of catalytic residue, by the addition of sepiolites. Adsorbents have the advantage of being a less harsh treatment compared to the above chemical treatments, and they can be removed by filtration since they remain insoluble in the polyol.

U.S. Pat. No. 8,354,559 discloses synthetic aluminum silicate, synthetic alumina/magnesia and synthetic hydrotalcite with defined particle sizes that include >90% of the adsorbent to be less than 44 μm, were used to remove the total metal content of the polyol to less than 1 ppm. Adsorbents with larger particle sizes were found to be less effective at catalyst removal.

U.S. Pat. No. 6,930,210 describes the use of sepiolites for catalyst reduction to less than 1 ppm. Sepiolite is a naturally occurring magnesium silicate. Removal of the catalyst was successful using from 0.5 to 1 wt. % solid sepiolite.

Montmorillonite, another inorganic adsorbent, is also effective in removing DMC catalysts from polyols. Montmorillonite is less effective than sepiolite, and the filtration properties were similarly poor. The chemical makeup of montmorillonite is more complex than that of sepiolite as it contains sodium, calcium, aluminum silicate, magnesium silicate, etc. Magnesium silicate is also found in sepiolite.

Purification of polyols prepared from double metal cyanide complex catalysts are disclosed in U.S. Pat. No. 4,877,906. This method for removing the DMC catalyst uses alkali metal compounds and phosphorous compounds to precipitate the residual catalyst, which is then removed by filtration. One embodiment describes treating a propylene oxide polyol with a sodium metal dispersion, capped with ethylene oxide, treated with magnesium silicate, and then filtered through a cake of diatomaceous earth filter aid to remove at least a portion of the catalyst. The catalyst removal is then substantially completed by treating the polyol with hypophosphorous or phosphorous acid to precipitate the remaining solubilized double metal cyanide complex catalyst residue, neutralizing the excess acid with magnesium silicate and filtering the polyol again.

U.S. Pat. No. 9,527,958 describes the selection of a specific grade range of diatomaceous earth allows for adsorption of the catalyst while maintaining unique improved flow rates. It is disclosed that this is due to the porous nature of the biogenic silica in diatomaceous earths as compared to the affective natural clays in sepiolite and other natural adsorbents. Diatomaceous earth also has a higher purity with regard to silica content and greater composition consistency than the clays. The literature reports that sepiolite typically has a silica range of 58 to 75% with the average of 68%. See “Developments in Palygorskite-Sepiolite Research: A New Outlook on these Nanomaterials”, by A. Singer and E. Galan; Vol. 3; Elsevier: UK, 2011; p. 38. By comparison, the silica range of diatomaceous earths is typically from 80 to 90%. See “Diatomite: U.S. Geological Survey Mineral Commodity Summaries” 1998, by L. E. Antonides; p. 56-57.

### SUMMARY OF THE INVENTION

This invention relates to a process for producing a high purity polyether carbonate polyol which contains a low level of catalyst residues. This process comprises step (1) adding from 0.1% to 10% by weight, based on 100% by weight of polyether carbonate polyol, of activated carbon, to the polyether carbonate polyol; step (2) mixing the composition formed in (1) for a time period of from 20 minutes to 5 hours at temperature in the range of from 20° C. to 150° C.; and step (3) filtering the mixed com position from (2), thereby forming the high purity polyether carbonate polyol.

In an embodiment of the invention, the activated carbon added in step (1) is 0.5 to 2.0% by weight, based on the weight of the polyether carbonate polyol. In another, it is 0.75 to 1.5% by weight. In other embodiments, the activated carbon is acid washed, and/or the activated carbon is a powder.

In additional embodiments, the composition in step (2) is mixed for a time period of from 30 minutes to 120 minutes, or from 45 minutes to 90 minutes. In still another embodiment, the composition in step (2) is mixed at a temperature in the range of from 70° C. to 125° C.

In yet another embodiment, the filtering in step (3) is done by a filter paper, which may have a pore size of 10-30 μm. In other embodiments of the invention, the polyether carbonate polyol is prepared with a double metal cyanide catalyst. In another, at least 60% of one of cobalt or zinc is removed from the polyether carbonate polyol. In still another, the high purity polyether carbonate polyol contains no more than 6 ppm of cobalt residue.

In a different embodiment, the filtering in step (3) is through a filter that has been pre-coated with activated carbon. The filter paper may be pre-coated by the steps comprising: (a) dispersing activated carbon in a solvent to form a mixture, (b) passing the mixture of (a) through a filter paper, and (c) drying the mixture on the filter paper. In more embodiments, the activated carbon substantially covers the area of filter through which the mixed composition will pass. In another, the concentration of activated carbon on the filter is between about 0.05 g/cm² and about 10 g/cm².

### DETAILED DESCRIPTION OF THE INVENTION

The present invention will now be described for purposes of illustration and not limitation. Except in the operating examples, or where otherwise indicated, all numerical parameters are to be understood as being prefaced and modified in all instances by the term “about”, in which the numerical parameters possess the inherent variability characteristic of the underlying measurement techniques used to determine the numerical value of the parameter. Examples of such numerical parameters include, but are not limited to OH numbers, equivalent and/or molecular weights, functionalities, amounts, percentages, etc. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited herein is intended to include all sub-ranges subsumed within the recited range. For example, a range of “1 to 10” is intended to include all sub-ranges between (and including) the recited minimum value of 1 and the recited maximum value of 10, that is, having a minimum value equal to or greater than 1 and a maximum value equal to or less than 10. All end points of any range are included unless specified otherwise. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are inherently described in this specification such that amending to expressly recite any such sub-ranges would comply with the requirements of 35 U.S.C. § 112 and 35 U.S.C. § 132(a).

The grammatical articles “a”, “an”, and “the”, as used herein, are intended to include “at least one” or “one or more”, unless otherwise indicated, even if “at least one” or “one or more” is used in certain instances. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

Equivalent weights and molecular weights given herein in Daltons (Da) are number average equivalent weights and number average molecular weights respectively, unless indicated otherwise. Permeability is given here in darcys (D). Flow rate is given herein in kg/m²·h.

As used herein, the term cobalt metal refers to the cobalt complex a part of the total catalyst residue.

The ppm of catalyst residues of the polyether carbonate polyols as disclosed herein were calculated based on the actual measurement of cobalt residues (in ppm) present in the polyether carbonate polyols. Zinc residues (in ppm) present in the polyether carbonate polyols were also measured. The amount of zinc is typically about 18% to 26% of the total catalyst residue, and the amount of cobalt is typically about 8% to 12% of the total catalyst residue.

The high purity polyether carbonate polyols produced by the present process are polyether carbonate polyols which are characterized by low levels of catalyst residues. It is desirable to remove catalyst residues from polyether carbonate polyols to levels consistent with commercially available polyether polyols.

As used herein, a low level of catalyst residues refers to a polyether carbonate polyol that contains less than or equal to 90 ppm of catalyst residues, or 9 ppm cobalt metal contained in the catalyst residue. In the instant application, the total amount of catalyst residue is inferred or calculated from the cobalt analysis. For DMC catalysts, the cobalt content can be as low as approximately 8%, or approximately 9% of the catalyst residue. The cobalt content can also be as high as approximately 12%, or approximately 11% of the catalyst residue. Thus, the cobalt content can range from approximately 8% to approximately 12%, or from approximately 9% to approximately 11%. In addition, the cobalt content in the catalyst residue can be approximately 10% of the total amount of catalyst residue.

The amount of catalyst residues present in the high purity polyether carbonate polyols can be less than or equal to 90 ppm, less than or equal to 60 ppm, less than or equal to 30 ppm, or less than or equal to 15 ppm. The amount of catalyst residues present in the polyether carbonate polyols is typically at least 5 ppm. The amount of catalyst residues present in the polyether carbonate polyol can range from 5 to 90 ppm, from 5 to 60 ppm, from 5 to 30 ppm, and from 5 to 15 ppm.

When measuring cobalt metal present in the polyether carbonate polyol, the amount of cobalt metal present can be less than or equal to 9 ppm, less than or equal to 6 ppm, less than or equal to 3 ppm, or less than or equal to 1.5 ppm. The amount of cobalt metal is typically at least 0.5 ppm. The amount of cobalt metal present can range from 0.5 to 9 ppm, from 0.5 to 6 ppm, from 0.5 to 3 ppm, and from 0.5 to 1.5 ppm.

Polyether carbonate polyols suitable for use in the present invention include, for example, those obtained via an addition reaction of carbon dioxide and of alkylene oxides onto H-functional starter substances. For the purposes of the present invention, “H-functional” means a starter compound which has H atoms that are active in relation to alkoxylation.

The production of polyether carbonate polyols via an addition reaction of alkylene oxides and CO₂ onto H-functional starters is described, for example, in U.S. Pat. Nos. 4,826,887, 7,977,501, 8,134,022, and 8,324,419.

In certain embodiments of the present invention, the content of carbonate groups, calculated as CO₂ in the polyether carbonate polyol, is within the range of 3 to 35% by weight, such as 5 to 30% by weight, 10 to 28% by weight, or, in some cases 10 to 20% by weight or 10 to 15% by weight. The determination method is NMR, using the analysis method specified in United States Patent Application Publication No. 2015/0232606 A1 at [0071]-[0073], the cited portion of which being incorporated herein by reference. In particular, according to such a method, the CO₂ content incorporated within the polyether carbonate polyol is determined by means of ¹H NMR (Bruker, DPX 400, 400 MHz: pulse program zg30, delay 5 s, 100 scans) in which the sample is dissolved in deuterated chloroform. Internal standard is added to the deuterated solvent comprised dimethyl terephthalate (2 mg for every 2 g of CDCl₃). The relevant resonances in the ¹H NMR (based on MCI; =7.24 ppm) are as follows: Carbonates, resulting from carbon dioxide incorporated within the polyether carbonate polyol (resonances at from 5.2 to 4.8 ppm), PO not consumed in the reaction with resonance at 2.4 ppm, polyether polyol (i.e. without incorporated carbon dioxide) with resonances at from 1.2 to 1.0 ppm. The molar content of the carbonate incorporated within the polymer, of the polyether polyol fractions, and also of the PO not consumed in the reaction are determined via integration of the corresponding signals.

In some embodiments of the present invention, the number-average molar mass (also referred to herein as Mₙ), of the polyether carbonate polyol is within the range of 500 and 10000 g/mol, such as 500 to 7500 g/mol, 750 to 6000 g/mol, 1000 to 5000 g/mol, or, in some cases, 1500 to 4000 g/mol. The determination method is titration of the terminal OH groups, using the analysis method specified in United States Patent Application Publication No. 2015/0232606 A1 at [0074], the cited portion of which being incorporated herein by reference. In particular, Mₙ is determined as follows: the OH number is first determined experimentally via esterification followed by back-titration of the excess esterification reagent with standard alcoholic potassium hydroxide solution in accordance with DIN 53240-2. The OH number is stated in mg KOH per gram of polyol. The Mₙ is calculated from the OH number by way of the equation:

$${M}_{n} = \frac{56100 * f}{OH \#}$$

in which f is the OH functionality of the compound (i.e., the number of hydroxyl groups per molecule), and OH# is the hydroxyl number of the polyol and is equal to the mass in milligrams of potassium hydroxide (56.1 grams/mol) equivalent to the hydroxyl content in one gram of the polyol compound (mg KOH/g). The OH functionality referred to herein is the theoretical average nominal functionality of the polyol, i.e., the functionality calculated based on the average number of hydroxyl groups per molecule of starter used to produce the polyol. On the other hand, in the case of monomeric polyols with a defined structure, the molar mass is calculated from the molecular formula.

In certain embodiments of the present invention, the OH functionality of the polyether carbonate polyol is at least 1, such as 1 to 8, 1 to 6, 2 to 4, 2.5 to 3.5, or, in some cases 2.8 to 3.2.

Production of the polyether carbonate polyols can generally use alkylene oxides (epoxides) having from 2 to 24 carbon atoms, specific examples of which include, but are not necessarily limited to, ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats in the form of mono-, di-, and triglyceride, epoxidized fatty acids, 01-C24-esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate, and also epoxy-functional alkoxysilanes, for example 3-glycidyloxypropyltrimethoxysilane, 3-glycidyloxypropyltriethoxysilane, 3-glycidyloxypropyltripropoxysilane, 3-gycidyloxypropylmethyldimethoxysilane, 3-glycidyloxypropylethyldiethoxysilane, and 3-glycidyloxypropyltriisopropoxysilane. Mixtures of two or more of any of the foregoing may be used. In some cases, ethylene oxide and/or propylene oxide is used.

In certain embodiments the proportion of ethylene oxide used is 0 to 90% by weight, such as 0 to 50% by weight, or, in some cases 0 to 25% by weight, based on the total weight of alkylene oxides used. In certain embodiments the proportion of propylene oxide used is 10 to 100% by weight, such as 50 to 100% by weight, or, in some cases 75 to 100% by weight, based on the total weight of alkylene oxides used.

Compounds having H atoms that are active in relation to alkoxylation are used as H-functional starters. Specific examples of such compounds are those having —OH, —NH₂ (primary amines), —NH— (secondary amines), —SH, and/or —CO₂H groups. Specific, but not necessarily limiting, examples of suitable such starters are polyhydric alcohols, polyfunctional amines, polyfunctional thiols, amino alcohols, thin alcohols, hydroxyesters, polyether polyols, polyester polyols, polyester ether polyols, polyether carbonate polyols, polycarbonate polyols, polycarbonates, polyethyleneimines, polyether amines (such as those known as Jeffamine® from Huntsman), polytetrahydrofurans (such as PolyTHF® from BASF, including PolyTHF® 250, 650S, 1000, 1000S, 1400, 1800, 2000), polytetrahydrofuranamincs (BASF product polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and alkyl fatty acid esters having an average of at least two OH groups per molecule. The C1-C24 alkyl fatty acid esters having an average of at least two OH groups per molecule are, for example, commercially available products such as Lupranol Balance® (BASF AG), Merginol® grades (Hobum Oleocheinicals GmbH), Sovermol® grades (Cognis Deutschland GmbH & Co. KG), and Soyol®TM grades (USSC Co.).

Specific, but not necessarily limiting, examples of suitable polyhydric alcohols for use as H-functional starter are dihydric alcohols, such as ethylene glycol, diethylene glycol, propylene glycol, dipropylene 1,3-propanediol, 1,4-butanediol, 1,4-butenediol, 1,4-butynediol, neopentyl glycol, 1,5-pentanediol, methylpentanediol (e.g. 3-methyl-1,5-pentanediol), 1,6-hexanediol, 1,8-octanediol, 1,10-decanediol, 1,12-dodecanediol, bis(hydroxymethyl)-cyclohexanes (e.g. 1,4-bis(hydroxymethyl)cyclohexane), triethylene glycol, tetraethylene glycol, polyethylene glycol, dipropylene glycol, tripropylene glycol, polypropylene glycol, dibutylene glycol, and polybutylene glycols, and also all of the modification products of these abovementioned alcohols with various quantities of ε-caprolactone. Mixtures of H-functional starters can also use trihydric alcohols, for example trimethylolpropane, glycerol, trishydroxyethyl isocyanurate, and castor oil.

The H-functional starter can also include polyether polyols, such as those with a number-average molar mass Mₙ in the range from 200 to 4000 g/mol, such as 250 to 2000 g/mol. In certain embodiments, such polyether polyols are composed of repeating units of ethylene oxide and of propylene oxide, often having a proportion of from 35 to 100% of propylene oxide units, such as a proportion of from 50 to 100% of propylene oxide units. These can be random copolymers, gradient copolymers, or alternating or block copolymers of ethylene oxide and propylene oxide. Examples of suitable polyether polyols composed of repeating units of propylene oxide and/or of ethylene oxide are the Desmophen®, Acclaim®, Arcol®, Baycoll®, Bayfill®, Bayflex®, Baygal®, PET®, and polyether polyols from Covestro AG (e.g. Desmophen® 3600Z, Desmophen® 19000, Acclaim® Polyol 2200, Acclaim® Polyol 42000, Arcol® Polyol 1004, Arcol® Polyol 1010, Arcol® Polyol 1030, Arcol® Polyol 1070, Baycoll® BD 1110, Bayfill® PPU 0789, Baygal® K55, and PET® 1004). Examples of other suitable homopolyethylene oxides are the Pluriol® F grades from BASE SE, and examples of suitable homopolypropylene oxides are the Pluriol® P grades from BASF SE, and examples of suitable mixed copolymers of ethylene oxide and propylene oxide are the Pluronic® PE or Pluriol® RPE grades from BASF SE.

Suitable H-functional starters can also include polyester polyols, such as those with a Mₙ in the range from 200 to 4500 g/mol, such as 400 to 2500 g/mol. Polyester polyols are often composed of alternating acid units and alcohol units. Examples, but not necessarily limiting examples, of acid components used are succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, and mixtures of the acids and/or anhydrides mentioned. Examples, but not necessarily limiting examples, of alcohol components used are 1,2-ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, and mixtures of two or more of any of the foregoing. If dihydric or polyhydric polyether polyols are used as alcohol component, polyester ether polyols are obtained and can likewise serve as H-functional starter for the production of the polyether carbonate polyols. If polyether polyols are used for the production of the polyester ether polyols, it is sometimes desirable to use polyether polyols with a Mₙ of from 150 to 2000 g/mol.

Other H-functional starters that can be used are polycarbonate polyols, for example polycarbonate diols, such as those with a Mₙ of 150 to 4500 g/mol, such as 500 to 2500 g/mol, these being produced, for example, via reaction of phosgene, dimethyl carbonate, diethyl carbonate, or diphenyl carbonate and di- and/or polyhydric alcohols, or polyester polyols, or polyether polyols. Examples of polycarbonate polyols are described, for example, in U.S. Pat. No. 6,767,986, which is incorporated herein by reference. Polycarbonate diols used are commercially available and include, for example, the Desmophen® C grades from Covestro LLC, Pittsburgh, Pa., e.g. Desmophen® C 1100 or Desmophen® C 2200.

Polyether carbonate polyols can likewise be used as H-functional starters. In particular, the polyether carbonate polyols described in this specification can themselves be used as H-functional starters. These polyether carbonate polyols used as H-functional starters are produced in advance for this purpose in a separate reaction step.

The functionality (i.e. number of H atoms per molecule that are active in relation to polymerization) of the H-functional starter is generally from 1 to 4, such as 2 or 3. The H-functional starters are used either individually or in the form of mixture of at least two H-functional starters.

In some embodiments of the present invention, the H-functional starter comprises an alcohol of the general formula (I),

HO—(CHₓ)—OH (I)

in which x is a number from 1 to 20, such as an even number from 2 to 20. Non-limiting examples of alcohols of formula (I) are ethylene glycol, 1,4-butanediol, 1,6-hexanediol, 1,8-octanediol, 1,10-decanediol, and 1,12-dodecanediol. Other suitable H-functional starters are neopentyl glycol, trimethylolpropane, glycerol, pentaerythritol, reaction products of the alcohols of formula (I) with ε-caprolactone, e.g. reaction products of trimethylolpropane with ε-caprolactone, reaction products of glycerol with ε-caprolactone, and also reaction products of pentaerythritol with ε-caprolactone. In some cases, the H-functional starter comprises water, diethylene glycol, dipropylene glycol, castor oil, sorbitol, and polyether polyols composed of repeating units of polyalkylene oxides.

In some embodiments, the H-functional starter comprises ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerol, trimethylolpropane, and/or a di- and trihydric polyether polyol, where the polyether polyol is composed of a di- or tri-H-functional starter substance and propylene oxide or of a di or tri-H-functional starter substance, propylene oxide, and ethylene oxide. The Mₙ of the polyether polyol is, in certain embodiments, in the range from 62 to 4500 g/mol, such as 62 to 3000 g/mol, or 62 to 1500 g/mol. The OH functionality of the polyether polyols is, in many embodiments, 2 to 3.

In certain embodiments of the present invention, the polyether carbonate polyol having an incorporated carbon dioxide content is the addition reaction product of carbon dioxide and alkylene oxide(s) onto H-functional starter(s) with the use of a multimetal cyanide catalyst (DMC catalyst).

DMC catalysts suitable for use in preparing such polyether carbonate polyols are disclosed, for example, in U.S. Pat. Nos. 3,404,109, 3,829,505, 3,941,849, and 5,158,922. DMC catalysts described by way of example in U.S. Pat. No. 5,470,813, EP 700 949 A, EP 743 093 A, EP 761 708 A, WO 97/40086 A, WO 98/16310 A and WO 00/47649 A have very high activity in the homopolymerization of epoxides, and permit the production of polyether polyols at very low catalyst concentrations (25 ppm or less). The high-activity DMC catalysts described in EP-A 700 949 are a typical example, and comprise not only a double metal cyanide compound (e.g. zinc hexacyanocobaltate(III)) and an organic ligand (e.g., tert-butanol), but also a polyether with a number-average molar mass greater than 500 g/mol.

The amount of DMC catalyst used is, in certain embodiments, less than 1% by weight, such as less than 0.5% by weight, less than 500 ppm, or, in some cases, less than 300 ppm, based on the total weight of the polyether carbonate polyol.

The following examples further illustrate details for the process of this invention.

### EXAMPLES

The following materials were used in the working examples.

Polyol A: a poly(oxypropylene carbonate) polyol, started with a poly(oxypropylene) polyol having a 56 hydroxyl number and a functionality of 2.8, formed by the random copolymerization of propylene oxide and carbon dioxide. The final product was characterized by a hydroxyl number of 56, functionality of 2.8, a viscosity of 15000 cSt, and carbonate concentration of approximately 19.5%.

Polyol B: a trifunctional polyether polyol with an OH number of 48 mg KOH/g, prepared by the DMC-catalyzed alkoxylation of glycerol and propylene glycol with a mixture of propylene oxide and ethylene oxide in proportions of 88/12, and with approx. 8 mol % of primary OH groups. The viscosity is 700 cSt at 25° C., maximum 735 cSt a t 25° C.

Polyol a was Prepared Using the Following Method:

A continuously operated 60 L pressure reactor with gas metering unit and product discharge tube was initially charged with 32.9 L of a polyether carbonate polyol (OH functionality=2.8; OH number=56 mg KOH/g; CO₂ content=20% by weight) containing 200 ppm of DMC catalyst. At a temperature of 108° C. and a pressure of 65 bar (absolute), the following components were metered at the metering rates specified while stirring (9 Hz):
propylene oxide at 7.0 kg/h
carbon dioxide at 2.3 kg/h
mixture of glycerol/propylene glycol (85% by weight/15% by weight) containing 0.69% by weight of DMC catalyst (unactivated) and 146 ppm (based on the starter mixture) of H₃PO₄ (in the form of an 85% aqueous solution) at 0.27 kg/h.

The reaction mixture was removed continuously from the pressure reactor via the product discharge tube so that the reaction volume (32.9 L) was kept constant, the average residence time of the reaction mixture in the reactor being 200 min. To complete the reaction, the withdrawn reaction mixture was transferred to a post-reactor (tube reactor with a reaction volume of 2.0 L) which was heated to 120° C. The average residence time of the reaction mixture in the post-reactor was 12 min. The product was then decompressed to atmospheric pressure and then mixed with 500 ppm of antioxidant Irganox® 1076.

The product was then brought to a temperature of 120° C. by means of a heat exchanger and immediately thereafter transferred into a 332 L vessel and kept at the temperature of 1200 for a residence time of 4 hours. After completion of the residence time, 40 ppm phosphoric acid was added to the product.

Finally, cyclic propylene carbonate was removed by a two-stage thermal processing, wherein in a first stage a falling film evaporator is used, and in a second stage a stripping column is operated with a nitrogen countercurrent.

The falling film evaporator was operated at a temperature of 160° C. under a pressure of 10 mbar (absolute). The falling film evaporator is made of glass with an exchange area of 0.5 square meters. The apparatus has an externally heated tube with a diameter of 115 mm and a length of about 1500 mm.

The nitrogen stripping column is operated at a temperature of 160° C., a pressure of 80 mbar (absolute), and a nitrogen flow rate of 0.6 kg N₂/kg of product. The stripping column used was a DN80 glass column with a filling height of 8 m (Raschig Super-Rings #0.3).

The OH number, the viscosity, the content of incorporated carbon dioxide and the content of cyclic propylene carbonate were determined from the polyether carbonate polyol obtained.

Polyol B was Prepared Using the Following Method:

Propylene oxide and ethylene oxide are reacted together, with a starter consisting of 15% propylene glycol in glycerin. The glycerin is acidified with 75 ppm phosphoric acid. The catalyst is Arcol Catalyst 3, available from Covestro LLC, Pittsburgh, Pa. The dry catalyst powder is dispersed in the starter, which is fed into the reactor. The concentration of catalyst to polypropylene glycol is 1 wt. %. The reaction temperature is 130° C. Agitation is minimum 1.5 kW/1000 liters on a final batch basis. Total ethylene oxide is 10.5 wt. % based on the final product weight. At steady state, the feeds have the following weight ratios to the propylene oxide (PO) feed: Ethylene Oxide/PO 12.097%, Glycerin/PO 2.6489%, Propylene Glycol/PO 0.1793%, (Propylene Glycol+Catalyst)/PO 0.2881%.

The reactor is operated in a liquid full mode of operation and the overflow of the reactor is controlled by back pressure. The minimum residence time is 2.7 hours. The cook out is conducted in a plug flow or a CSTR that has a minimum residence time of 30 minutes at 130° C. After cook out, the final product can be continuously stripped in packed columns using steam and nitrogen.

Seventeen different activated carbons were screened. The carbons had rod, granular and powder morphologies and ranged in size from 3-4 mm, 0.8-2 mm and 0.01-0.074 mm respectively. Some of the carbons were washed with one or a combination of hydrochloric, sulfuric and phosphoric acid by the manufacturer. The carbons were supplied by Sigma-Aldrich Corporation, St. Louis, Mo. or Cabot Corporation, Boston, Mass.

250 g of a mixture of Polyol A and Polyol B was placed in round bottom flask equipped with an overhead stirrer. To the polyol mixture was added 1 wt. % of activated carbon. Prior to use all carbons were washed with hexanes and dried with nitrogen. The polyol carbon mixture was stirred at 100° C. for 1 hour under nitrogen. The hot mixture was then filtered through a nylon filter paper with a 20 μm pore size. The filtrate was collected in two fractions. The first fraction consisted of the first 10% of the solution only, and the remainder of the polyol filtrate was collected as the second fraction. A sample of the untreated polyol mixture was used as the control sample. A control sample was analyzed with each batch of samples.

The effectiveness of each carbon sample was determined by measuring the Co and Zn content in each of the carbon samples, after they were used with the polyol mixture, and then calculating the percentage of Co and Zn that were removed from the sample. Control samples were used, and the Co and Zn content were measured in those samples as well. For example, a control sample was found to contain 19.22 ppm Co and a 75 g first fraction was found to contain 17 ppm Co, and a 150 g second fraction was found to contain 18 ppm Co. The average Co concentration is then calculated as (17 ppm×75 g+18 ppm×150 g)/(75 g+150 g)=17.67 ppm. The Co removed is calculated as 19.22 ppm-17.67 ppm=1.55 ppm, and the % removed is calculated as 1.55 ppm/19.22 ppm=8.1%. A summary of each test of activated carbon is listed below in Table 1.

TABLE 1

| | | | Concentration | | | | |
|---|---|---|---|---|---|---|---|
| | | | of Co/Zn | Concentration | Concentration | Average | Average |
| | | Manufacturer’s | untreated | of Co/Zn in 1^{st} | of Co/Zn in 2^{nd} | % Co | % Zn |
| Activated carbon | Morphology | Treatment | polyol/ppm | fraction/ppm | fraction/ppm | removed | removed |
| Sigma Aldrich | Granular | Untreated | 19.2/43.6 | 16.9/37 | 17.5/40 | 9.3 | 9.4 |
| C2289 | | | | | | | |
| Sigma Aldrich | Powder | No information | 19.2/43.6 | 14.4/29.2 | 14/28.4 | 26.6 | 34.5 |
| C3345 | | | | | | | |
| Sigma Aldrich | Rod | No information | 19.2/43.6 | 17.2/39.1 | 17.2/39.9 | 10.3 | 8.8 |
| 29204 | | | | | | | |
| Cabot DARCO | Powder | Acid washed | 19.0/43.8 | 11/25.1 | 5.2/10.9 | 65.5 | 67.4 |
| S-51 M-2005 | | | | | | | |
| Cabot Norit PAC | Powder | No information | 19.0/43.8 | 13.1/29.4 | 11.6/26.1 | 37 | 38.6 |
| 20B M-2048 | | | | | | | |
| Cabot Norit GAC | Granular | No information | 19.0/43.8 | 17.1/38.4 | 17.2/38.7 | 9.7 | 11.9 |
| 1240 M-1919 | | | | | | | |
| Cabot DARCO | Granular | Acid washed | 19.0/43.8 | 16.7/37.7 | 16.7/37.3 | 12.3 | 14.6 |
| 12X40 M-2027 | | | | | | | |
| Sigma Aldrich | Powder | No information | 19.2/44.6 | 11.8/27.6 | 10.1/22.6 | 45.8 | 47.3 |
| 675326 | | | | | | | |
| Cabot DARCO | Powder | Activation | 19.2/49.4 | 12/27.4 | 10.5/26.8 | 43.7 | 45.5 |
| KBG 3657617 | | using H₃PO₄ | | | | | |
| | | process | | | | | |
| Sigma Aldrich | Granular | No information | 19.2/49.5 | 15.9/39.6 | 15.4/39.7 | 18.9 | 19.7 |
| 05112 | | | | | | | |
| Sigma Aldrich | Powder | Washed with | 19.2/49.6 | 11.8/35.5 | 11.2/29.9 | 40.5 | 35.4 |
| 4386 | | HCl | | | | | |
| Sigma Aldrich | Powder | No information | 19.2/49.7 | 12.6/31.9 | 12/29.8 | 36.1 | 38 |
| 05120 | | | | | | | |
| Sigma Aldrich | Powder | Washed with | 19.2/44.6 | 9.8/21.5 | 5.3/12.2 | 64.4 | 65.5 |
| C5510 | | H₃PO₄ and H₂SO₄ | | | | | |
| Sigma Aldrich | Powder | Washed with | 19.2/44.6 | 13.3/30.4 | 8/18.8 | 51.8 | 51.6 |
| C9157 | | HCl | | | | | |
| Sigma Aldrich | Rod | No information | 19.2/44.6 | 16.7/39.2 | 16.9/39.9 | 12.4 | 10.6 |
| 29238 | | | | | | | |
| Sigma Aldrich | Rod | No information | 19.2/44.6 | 17.1/40.1 | 17.2/40.4 | 10.5 | 9.4 |
| Norit RB4C | | | | | | | |
| 51127 | | | | | | | |
| Cabot Norit | Granular | Activation | 19.2/43.6 | 17/38.2 | 16.5/37.8 | 13.5 | 13.1 |
| CGRAN 3547322 | | using H₃PO₄ | | | | | |
| | | process | | | | | |

As shown in Table 1, acid treated activated carbons Cabot DARCO S-51 M-2005 and Sigma Aldrich C5510, which are both powders, removed the most cobalt and zinc.

Next, optimization runs were performed using these two carbons. These modifications included changing the agitation speed, mixing time, amount of activated carbon used and assessing the effectiveness of pre-coating the filter paper with an activated carbon filter cake.

Each sample was first prepared as described above. Samples 1 and 4 used Cabot DARCO S-51 M-2005 activated carbon, while samples 2 and 3 used Sigma Aldrich 5510 activated carbon. Samples 1 and 2 were further treated by passing the solution through a filter paper that had been pre-coated with an activated carbon filter cake. This pre-coat was prepared by suspending about 10 g of activated carbon in a suitable solvent, to be applied to a filter paper of 142 mm in diameter. The activated carbon is applied such that the activated carbon substantially covers the entire area, except for 4 mm around the edge of the filter, or an area 134 mm in diameter, corresponding to 14,100 mm², or 141 cm². This results in a concentration of about 0.07 g/cm², although concentrations of 0.05 g/cm² to about 0.10 g/cm² may be used.

Hexane is used as the solvent to disperse the activated carbon, although other solvents may be used, in which activated carbon disperses well, and which will readily evaporate from the carbon. The mixture was then filtered through a nylon filter paper with a 20 μm pore size. This resulted in the formation of an activated carbon cake on the surface of the filter paper which was allowed to dry. The polyol mixture was then filtered using this pre-coated filter paper. In all runs in which a filter cake was used, the carbon used to purify the polyol was also used to make the filter cake.

Each of samples 1 and 2 used 1% loading of activated carbon, and a mixing time of 1 hour, similar to the conditions used above in Table 1. For samples 3 and 4, each solution was loaded with 10% activated carbon. As noted above, the mixing times were also tested; sample 3 was mixed for 1 hour as each of the previous samples, while sample 4 was mixed for 5 hours. The results of these optimization runs are shown in Table 2 below.

TABLE 2

| | Concentra- | Concentra- | Concentra- | | |
|---|---|---|---|---|---|
| | tion | tion | tion | | |
| | of Co/Zn in | of Co/Zn in | of Co/Zn in | | |
| Sam- | untreated | 1^{st} fraction/ | 2^{nd} fraction/ | % Co | % Zn |
| ple | polyol/ppm | ppm | ppm | removed | removed |
| 1 | 18.3/41.7 | 1.5/3.6 | 1.5/3.2 | 91.9 | 92 |
| 2 | 18.3/41.7 | 2.5/5.4 | 2.9/6.4 | 85 | 85.6 |
| 3 | 16.6/41.6 | <1.2/<0.8 | <1.2/<0.8 | >92.8 | >98.1 |
| 4 | 16.6/41.6 | <1.1/<0.7 | <1.2/<0.8 | >93.4 | >98.2 |

The optimization studies confirmed that Cabot DARCO S-51 M-2005 and Sigma Aldrich C5510 were the most effective at cobalt and zinc removal. These optimization studies showed that while increasing the carbon loading to 10% (samples 3 and 4) or increasing mixing time to 5 hours (sample 4) increased the amount of cobalt and zinc that was removed, the most efficient and effective way of maximizing cobalt and zinc removal was by employing the activated carbon filter cake. The use of the filter cake employing just 1 wt. % loading of carbon and a 1 hour mixing time, and was found to be surprisingly effective, in relative comparison to samples using a much higher loading of activated carbon.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

The following aspects are disclosed below:

1. A process for producing a high purity polyether carbonate polyol which contains a low level of catalyst residue, comprising
(1) adding from 0.1% to 10% by weight, based on 100% by weight of polyether carbonate polyol, of activated carbon, to the polyether carbonate polyol;
(2) mixing the composition formed in (1) for a time period of from 20 minutes to 5 hours at temperature in the range of from 20° C. to 150° C.; and
(3) filtering the mixed composition from (2), thereby forming the high purity polyether carbonate polyol.

2. The process of 1, wherein 0.5% to 2.0% by weight, based on 100% by weight of polyether carbonate polyol, of activated carbon is added in (1).

3. The process of 2, wherein 0.75% to 1.5% by weight, based on 100% by weight of polyether carbonate polyol, of activated carbon is added in (1).

4. The process of any of the preceding, wherein the activated carbon is acid washed.

5. The process of any of the preceding, wherein the activated carbon is a powder.

6. The process of any of the preceding, wherein the composition in (2) is mixed for a time period of from 30 minutes to 120 minutes.

7. The process of any of the preceding, wherein the composition in (2) is mixed for a time period of from 45 minutes to 90 minutes.

8. The process of any of the preceding, wherein the composition in (2) is mixed at a temperature in the range of from 70° C. to 125° C.

9. The process of any of the preceding, wherein the filtering in (3) is done by a filter paper.

10. The process of any of the preceding, wherein the filter paper has a pore size of 10-30 μm.

11. The process of any of the preceding, wherein the polyether carbonate polyol is prepared with a double metal cyanide catalyst.

12. The process of any of the preceding, wherein at least 60% of one of cobalt or zinc is removed from the polyether carbonate polyol.

13. The process of any of the preceding, wherein the high purity polyether carbonate polyol contains no more than 6 ppm of cobalt residue.

14. The process of any of the preceding, wherein the filtering in step (3) is through a filter that has been pre-coated with activated carbon.

15. The process of 14 and any of the preceding, wherein the filter paper is pre-coated by the steps comprising: (a) dispersing activated carbon in a solvent to form a mixture, (b) passing the mixture of (a) through a filter paper, and (c) drying the mixture on the filter paper.

16. The process of any of the preceding, wherein the activated carbon substantially covers the area of filter through which the mixed composition will pass.

17. The process of any of the preceding, wherein the concentration of activated carbon on the filter is between about 0.05 g/cm² and about 0.10 g/cm².

What is claimed is:

1. A process for producing a high purity polyether carbonate polyol which contains a low level of catalyst residue, comprising
(1) adding from 0.1% to 10% by weight, based on 100% by weight of polyether carbonate polyol, of activated carbon, to the polyether carbonate polyol;
(2) mixing the composition formed in (1) for a time period of from 20 minutes to 5 hours at temperature in the range of from 20° C. to 150° C.; and
(3) filtering the mixed composition from (2), thereby forming the high purity polyether carbonate polyol.

2. The process of claim 1, wherein 0.5% to 2.0% by weight, based on 100% by weight of polyether carbonate polyol, of activated carbon is added in (1).

3. The process of claim 2, wherein 0.75% to 1.5% by weight, based on 100% by weight of polyether carbonate polyol, of activated carbon is added in (1).

4. The process of claim 1, wherein the activated carbon is acid washed.

5. The process of claim 1, wherein the activated carbon is a powder.

6. The process of claim 1, wherein the composition in (2) is mixed for a time period of from 30 minutes to 120 minutes.

7. The process of claim 6, wherein the composition in (2) is mixed for a time period of from 45 minutes to 90 minutes.

8. The process of claim 1, wherein the composition in (2) is mixed at a temperature in the range of from 70° C. to 125° C.

9. The process of claim 1, wherein the filtering in (3) is done by a filter paper.

10. The process of claim 9, wherein the filter paper has a pore size of 10-30 μm.

11. The process of claim 1, wherein the polyether carbonate polyol is prepared with a double metal cyanide catalyst.

12. The process of claim 1, wherein at least 60% of one of cobalt or zinc is removed from the polyether carbonate polyol.

13. The process of claim 1, wherein the high purity polyether carbonate polyol contains no more than 6 ppm of cobalt residue.

14. The process of claim 1, wherein the filtering in step (3) is through a filter that has been pre-coated with activated carbon.

15. The process of claim 14, wherein the filter paper is pre-coated by the steps comprising: (a) dispersing activated carbon in a solvent to form a mixture, (b) passing the mixture of (a) through a filter paper, and (c) drying the mixture on the filter paper.

16. The process of claim 14, wherein the activated carbon substantially covers the area of filter through which the mixed composition will pass.

17. The process of claim 14, wherein the concentration of activated carbon on the filter is between about 0.05 g/cm² and about 0.10 g/cm².
